(19) United States
(12) Patent Application Publication
(10) Pub. No.: US 2025/0174954 A1
(43) Pub. Date: May 29, 2025

(54) HANDLING SYSTEM IN THE FORM OF AT LEAST ONE SHUTTLE FOR A WIRE ASSEMBLY MACHINE

(71) Applicant: SW AUTOMATISIERUNG GMBH, Golling an der Salzach (AT)

(72) Inventors: Johannes SCHAUER, Kuchl (AT); Rupert LINDNER, Kuchl (AT); Felix GRUENWALD, Bischofshofen (AT)

(21) Appl. No.: 18/958,606

(22) Filed: Nov. 25, 2024

(30) Foreign Application Priority Data
Nov. 29, 2023 (AT) A 50960/2023

(51) Int. Cl. H01R 43/052

(52) U.S. Cl. CPC H01R 43/052

(57) ABSTRACT

A handling system in the form of a shuttle for a wire assembly machine including a plurality of wire end processing stations. The shuttle includes gripper for holding a conductor, and a strand bundler separate from the gripper for bundling exposed strands, preferably from 3 mm to 30 mm and/or exposed from an insulation, of the conductor. The strand bundler is arranged on the shuttle in such a way that the strand bundler is movement-coupled to the gripper in a transport direction of the shuttle.

### BACKGROUND OF THE INVENTION

The invention relates to a handling system in the form of at least one shuttle for a wire assembly machine comprising a plurality of wire end processing stations, wherein the at least one shuttle has at least one gripper for holding at least one conductor. Furthermore, the invention relates to a wire assembly machine with at least one such handling system and to a method for bundling exposed strands of at least one conductor for a wire assembly machine by means of at least one such handling system.

Conventionally, shuttles are used as handling systems to transfer conductors between different wire end processing stations of a wire assembly machine as an aggregate in order to remove insulation from a conductor in certain regions and then to provide or join this exposed region of the conductor with a conductor end piece—for example in the form of a crimp connection.

A disadvantage of the prior art is that during the stripping of the conductor and the transport of the conductor to a crimping device, there is a tendency for individual exposed strands of the conductor to fray or protrude from the conductor in a radial direction, so that after inserting the conductor into the conductor end piece during the subsequent crimping process step, not all of the strands of the conductor are properly located within the conductor end piece or are bent or even located outside the conductor end piece. As an alternative, a conical funnel opening or a centering mandrel can be arranged in front of the crimping device, but this does not provide sufficient bundling or centering assistance for the large number of strands of common conductors in the electronics industry, since only a slight fanning out of the strands can be compensated.

### SUMMARY OF THE INVENTION

The technical object of the present invention is therefore to provide a handling system that is improved compared to the prior art, as well as a wire assembly machine and a method for bundling, in which the disadvantages of the prior art are at least partially eliminated. The handling system, wire assembly machine, and method are characterized by a particularly favorable handling of at least one free end of the at least one conductor in order to provide crimp connections with conductor end pieces that are as error-free as possible.

Therefore, according to the invention, the at least one shuttle comprises at least one strand bundler separate from the at least one gripper, for bundling exposed strands of the at least one conductor, which are exposed preferably from 3 mm to 30 mm and/or from insulation. The at least one strand bundler is arranged on the at least one shuttle in such a way that the at least one strand bundler is motion-coupled to the at least one gripper in a transport direction of the at least one shuttle.

This makes it possible for the exposed strands to be bundled centrally and held in a force-fitting manner by the at least one strand bundler after the stripping process step and during transport until the at least one conductor is connected to a conductor end piece, so that a particularly favorable connection of the at least one conductor to the conductor end piece can be ensured.

A spatial separation of the wire end processing stations (in particular the stripping unit and the crimping device) can thus be maintained. Despite the transport of the conductor, a proper bundling of the exposed strands on the crimping device can be ensured without having to provide a complex strand centering device on the crimping device to ensure crimp connections of sufficient quality.

However, the invention is not limited to the coupling of the at least one conductor with a conductor end piece. For example, the exposed strands can be processed in advance at another wire end processing station or, alternatively, processed in another way to form a crimp connection.

In addition, the at least one strand bundler can, in a free movement relative to the at least one gripper orthogonal to the transport direction—a decoupled direction of movement generally substantially normal to the transport direction—alternatively or additionally bring the insulation into a defined position relative to the at least one gripper.

In particular, in wire processing or transport processes in which no exposure of the strands from insulation is required or provided, a free end of the conductor (possibly of a single strand) can be maneuvered by the at least one strand bundler into a proper/correct or defined position relative to the processing station and/or the at least one gripper in order, for example, to stabilize and/or align a free end of the conductor hanging downwards due to gravity. The at least one strand bundler can thus function as an alternative or in addition to a centering and/or bundling function for exposed strands in a stabilizing and/or aligning function for the conductor—in particular exposed strands.

Another positive feature is that that the exposed strands are assuredly not undesirably fanned out during transport, wherein the time at which the exposed strands are bundled can be flexibly adjusted. For example, the bundling process can be temporarily set near the stripping and/or the decoupling process of the at least one strand bundler from the at least one conductor near the insertion process of the at least one conductor into the conductor end piece or can take place concurrently with the stripping process step or the insertion process step.

In addition, no separate entry to a bundling station with an additional loss of time is required. Bundling—which generally involves centering the exposed strands around a conductor symmetry axis—can, for example, be efficiently generated during the transport of at least one conductor. In an analogous manner, an opening process of the at least one strand bundler can be temporarily integrated essentially arbitrarily into the process sequence of the wire end processing, free from interaction with other component parts, in order to be able to achieve an efficient, simple and compact wire assembly machine.

The at least one gripper can ensure a relative positional securing of the at least one conductor with respect to the at least one shuttle. The at least one strand bundler generally fixes the exposed strands exclusively in a force-fitting manner in the radial direction—in contrast to the crimping device separate from the at least one strand bundler with plastic deformation of at least the conductor end piece.

When the handling system is equipped with at least one conductor, it can be inserted and fixed, for example, into a plastic collar or a metal collar of the conductor end piece in order to be used in electrical equipment.

Closing the at least one strand bundler can be defined, for example, by encompassing the exposed strands and limiting the radial distance of the exposed strands at least in the region of contact with the at least one strand bundler to an outer diameter of the previously existing insulation in this region. It is also conceivable that the at least one strand bundler only moves along the at least one conductor during closing, and the inner diameter of the strand bundler already substantially corresponds to the outer diameter of the insulation.

The handling system can be implemented as an add-on to an existing wire assembly machine for retrofitting without requiring a new design or adaptation of the structural design of the wire assembly machine.

As stated at the outset, protection is also sought for a wire assembly machine with at least two wire end processing stations and at least one such handling system for transporting at least one conductor between the at least two wire end processing stations.

The at least one handling system can act in a dual function when used on the wire assembly machine, wherein the at least one shuttle achieves both the transport and the bundling of the exposed strands.

As stated at the outset, protection is also sought for a method for bundling exposed strands of at least one conductor for a wire assembly machine, preferably such a wire assembly machine, by at least one such handling system, wherein the following method steps are carried out:
the at least one conductor is arranged on the at least one shuttle via the at least one gripper,
the at least one conductor is partially stripped of insulation at a stripping unit to expose the strands, and
the at least one conductor is transported by the at least one shuttle from the stripping unit to a wire end processing station, preferably a crimping device, wherein the at least one strand bundler, preferably arranged between the at least one gripper and a free end of the at least one conductor, bundles the exposed strands before or during or after transport to the wire end processing station.

According to an advantageous embodiment of the invention, the at least one strand bundler is arranged on the at least one shuttle in such a way that the at least one strand bundler is arranged between a free end of the conductor and the at least one gripper and/or oriented parallel to the at least one gripper when the conductor is arranged on the at least one shuttle.

This relative arrangement of the at least one strand bundler to the at least one gripper or to the free end of the at least one conductor on which the exposed strands are present makes it possible to provide a particularly compact, flexible and time-efficient handling system, since the at least one strand bundler only has to be moved in the direction of the free end (or vice versa) for bundling at an arbitrarily selectable time and can function in a supporting manner in addition to the at least one gripper for holding and aligning the at least one conductor.

Advantageously, the at least one shuttle has at least two grippers, preferably designed as a double gripper system and/or arranged on the same shuttle, for holding two free ends of a conductor and/or the at least one gripper has two holding jaws for force-fitting holding in the region of a free end of a conductor.

It has proven to be advantageous that the at least one shuttle has at least two strand bundlers, preferably designed as a further double gripper system and/or arranged on the same shuttle, for centering and holding the exposed strands and/or has two bundler jaws for force-fittingly holding the exposed strands in the region of a free end of a conductor.

Using a double gripper system or another double gripper system, two free ends of the same conductor or two conductors can be transported, bundled and, if necessary, processed in parallel at the same time.

According to an advantageous embodiment of the invention, the at least one strand bundler comprises at least one, preferably pneumatic, drive device for opening and/or closing the at least one strand bundler. Preferably, the at least one drive device is configured such that the at least one drive device opens and/or closes the at least one strand bundler before or during or after transport of the at least one strand bundler via the at least one shuttle.

For example, the at least one drive device can be designed to displace the at least one strand bundler relative to the at least one gripper and/or, preferably in an overlapping manner, to reduce or increase a spacing of the bundler jaws.

It has proven advantageous that the at least one shuttle comprises a movement device for the translational and/or servo-controlled transport of the at least one gripper and the at least one strand bundler. The at least one strand bundler can be displaced in a direction transverse to a transport direction of the at least one shuttle in a movement-decoupled manner from the at least one gripper and/or the exposed strands can be bundled and/or kept centered by the at least one strand bundler before, during, or after transport of the at least one strand bundler.

The primary functions of holding via the at least one gripper and bundling via the at least one strand bundler can thereby be separated from one another and activated and/or deactivated both locally and temporally at arbitrarily definable times.

An advantageous variant of the present invention consists in that the at least two wire end processing stations are arranged along a longitudinal extension and the at least one shuttle is movable along the longitudinal extension.

This aggregate of different processing entities enables, for example, particularly efficient mass production of conductors crimped with conductor end pieces, in which the possible capacity utilization of the individual wire end processing stations can be optimally utilized. For example, a plurality of shuttles can be moved along the transport direction parallel to the longitudinal extension in order to be able to carry out a crimping process and a stripping process at the same time.

A plurality of grippers of a shuttle can generally maintain a fixed distance or be moved relative to one another during the transport of the at least one conductor.

A plurality of strand bundlers of a shuttle can generally ensure bundling of the exposed strands of at least one conductor simultaneously or at different times.

Particularly preferably, the holding jaws for opening and closing the at least one gripper and/or the bundling jaws for opening and closing the at least one strand bundler are pivotable about an axis.

Preferably, one of the at least two wire end processing stations is in the form of at least one, preferably at least two, stripping units for partially removing insulation from the at least one conductor and/or at least one, preferably at least two, crimping devices for crimping the exposed strands with a conductor end piece, preferably wire end ferrule, twisted contact, cable lug, flat plug sleeve or crimp connection.

In one embodiment of the present invention, the at least one strand bundler is arranged in at least one transport position of the at least one shuttle, preferably in the region of one of the at least two wire end processing stations, between one of the at least two wire end processing stations and the at least one gripper. Preferably, the at least one strand bundler can be displaced in a movement-decoupled manner in the direction of one of the at least two wire end processing stations and/or orthogonally to a transport direction of the at least one shuttle from the at least one gripper, preferably for inserting the exposed strands into at least one collar of at least one conductor end piece.

According to a preferred embodiment of the invention, the at least one strand bundler comprises at least one drive device for opening and/or closing the at least one strand bundler, and the at least one drive device is configured such that the at least one drive device opens and/or closes the at least one strand bundler before or during or after transport of the at least one shuttle to one of the at least two wire end processing stations.

Furthermore, the exposed strands are bundled in a centered manner essentially on an outer diameter of the insulation of the at least one conductor, preferably by a relative movement of the at least one strand bundler with respect to the at least one gripper and/or the stripping unit in a direction transverse to a transport direction of the at least one shuttle and/or a longitudinal extension of the wire assembly device.

In a further embodiment, the exposed strands of the crimping device are fed in a bundle by the at least one strand bundler, preferably by a relative movement of the at least one strand bundler with respect to the at least one gripper and/or the stripping unit in a direction transverse to a transport direction of the at least one shuttle and/or a longitudinal extension of the wire assembly device, wherein the exposed strands are inserted centered into a conductor end piece and crimped with the conductor end piece.

It is particularly preferable that the at least one strand bundler is bundled during or after the strands are exposed by the at least one strand bundler on the stripping unit and/or during transport of the at least one conductor by the at least one shuttle from the stripping unit to the crimping device by the at least one strand bundler by closing the at least one strand bundler and/or the at least one strand bundler is opened during or after the exposed strands are inserted into a conductor end piece by the at least one strand bundler on the crimping device. Preferably, the exposed strands are kept bundled in a centered manner by the at least one strand bundler during transport of the shuttle from the stripping unit to the crimping device.

### BRIEF DESCRIPTION OF THE DRAWINGS

Further details and advantages of the present invention are explained in more detail below based on the description of the figures with reference to the exemplary embodiments shown in the drawings, in which:

FIGS. 1a-1j show a wire assembly machine with a handling system according to a preferred exemplary embodiment in different transport positions in perspective view,

FIGS. 2a-2j show the handling system according to the embodiment of FIGS. 1a-1j in different transport positions in perspective view,

FIGS. 3a-3j show the wire assembly machine according to the embodiment of Figs. 1a-1j in different transport positions, shown in orthogonal views with sectional views.

### DETAILED DESCRIPTION OF THE INVENTION

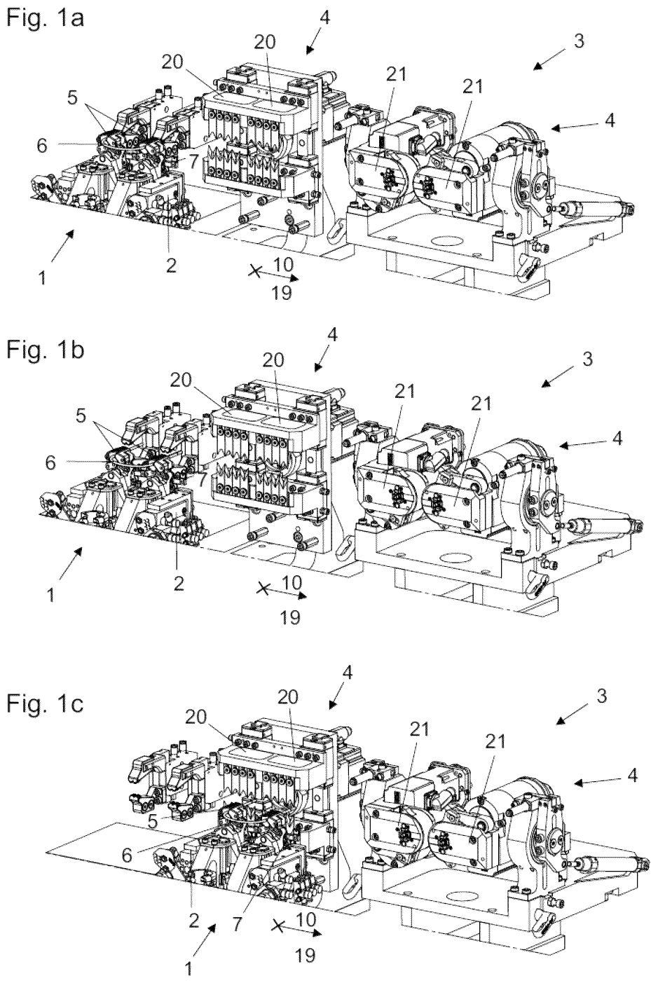

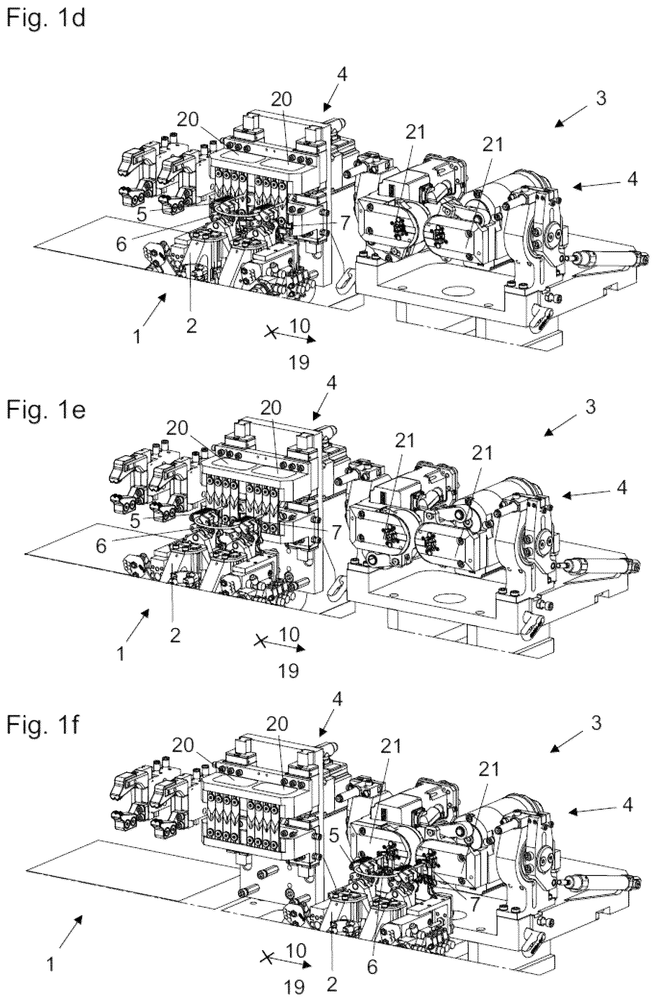

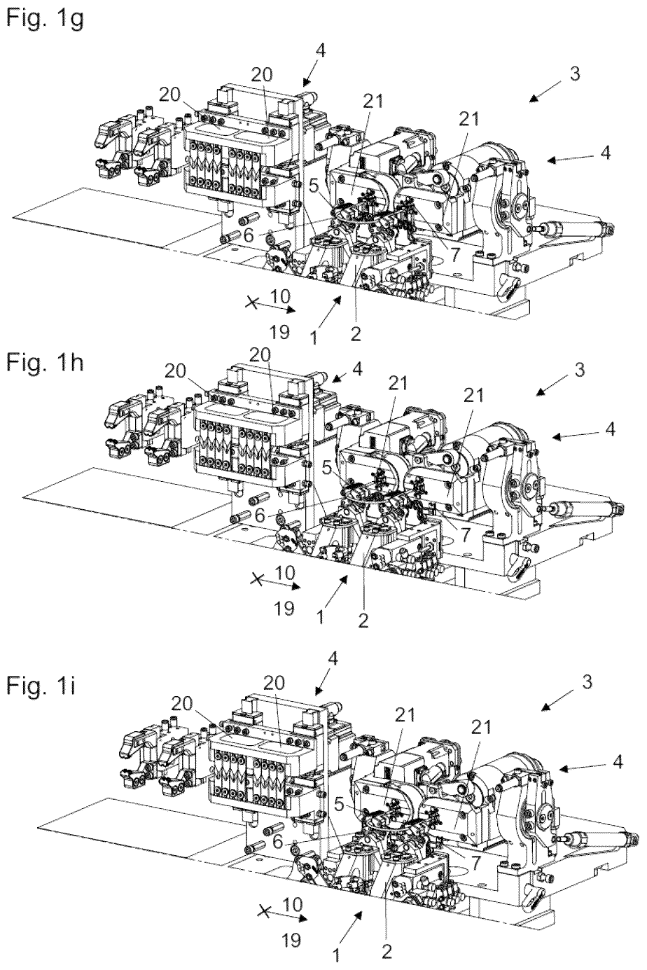

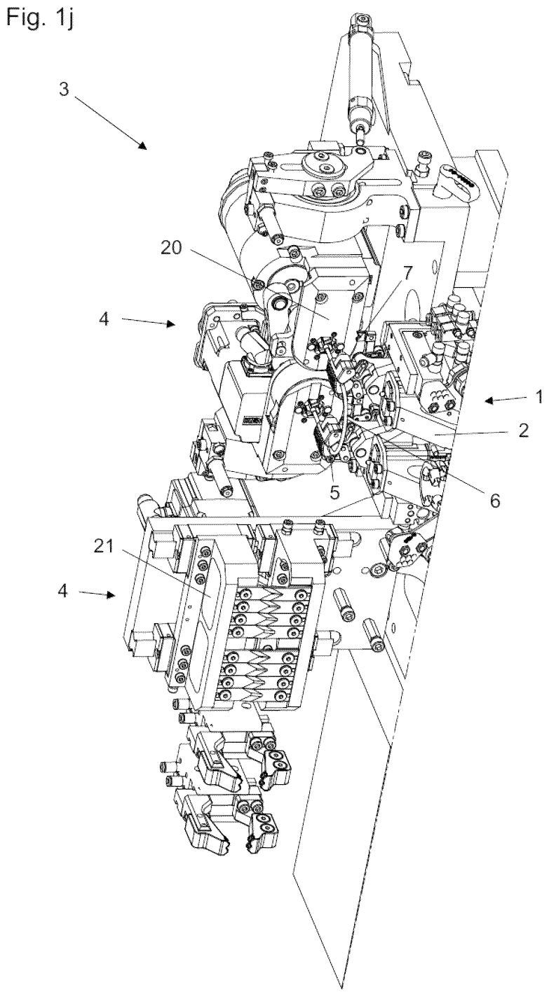

Fig. 1a to FIG. 1j show a wire assembly machine 3 with two wire end processing stations 4 and a handling system 1 for transporting a conductor 6 between the two wire end processing stations 4.

The handling system 1 is in the form of a shuttle 2 for the wire assembly machine 3, wherein the shuttle 2 has two grippers 5 for holding the conductor 6. The two wire end processing stations 4 are arranged along a longitudinal extension 19 and the shuttle 2 can be moved along the longitudinal extension 19.

The shuttle 2 comprises two strand bundlers 7 separate from the two grippers 5 for bundling strands 9 exposed from an insulation 8 of the conductor 6 in the end region of the conductor 6 during a stripping process. The two strand bundlers 7 are arranged on the shuttle 2 in such a way that the strand bundlers 7 are motion-coupled with the two grippers 5 in a transport direction 10 of the shuttle 2—parallel to the longitudinal extension 19. The number of shuttles 2, grippers 5 and strand bundlers 7 is generally arbitrary.

One of the two wire end processing stations 4 is provided as two stripping units 20 for the partial removal of the insulation 8 of the conductor 6. The further wire end processing station 4 is in the form of two crimping devices 21 for crimping the exposed strands 9 with a conductor end piece 22, wherein the conductor end piece 22 can be designed, for example, as a wire end sleeve, twisted contact, cable lug, flat plug sleeve, crimp connection etc. In general, the conductor 6 may already be in stripped form. In general, a crimping device 21 is not strictly necessary.

Fig. 1a shows a position of the wire assembly machine 3 in which the shuttle 2 picks up the conductor 6 from a transfer gripper of the wire assembly machine 3. FIG. 1b shows a position of the wire assembly machine 3 in which the transfer gripper is released from a contact of the conductor 6. FIG. 1c shows a position of the wire assembly machine 3 in which the shuttle is transported together with the conductor 6, which is held in the grippers 7, along the longitudinal extension 19 of the wire assembly machine 3 to the stripping units 20. In FIG. 1c, the strand bundlers 7 arranged on the shuttle 2 are in an open position.

FIG. 1d shows a position of the wire assembly machine 3 in which the stripping units 20 perform a stripping stroke in order to remove the insulation 8 in regions from the conductor 6 with the strand bundlers 7 open. Fig. 1e shows a position of the wire assembly machine 3 in which the grippers 5 and strand bundlers 7 have been moved relative to the stripping units 20 in order to strip the insulation 8 from the conductor 6. During this relative displacement, the strand bundlers 7 have moved into a closed position for the subsequent bundling of the exposed strands 9 of the conductor 6.

The strand bundlers 7 are arranged in the region of the remaining insulation 8. Alternatively, the closing process of the strand bundlers 7 can be carried out, for example, on the transport path of the shuttle 2 to or into the crimping devices 21 or the closing process can be accompanied by an arrangement of the strand bundlers 7 in the region of the exposed strands 9.

Fig. 1e shows a position of the wire assembly machine 3 in which the shuttle 2 has been transported to the crimping devices 21. Fig. 1f shows a position of the wire assembly machine 3 in which the grippers 5 and strand bundlers 7 have been moved relative to the crimping devices 21 in order to insert the exposed strands 9 of the conductor 6 in a bundled manner into a conductor end piece 22, wherein the strand bundlers 7 have been moved relative to the grippers 5 in order to center the exposed strands 9. The strand bundlers 7 are still in the closed position, wherein it is also possible to move the strand bundlers 7 into the open position during the relative movement of the conductor 6 in the direction of the crimping devices 21.

FIG. 1h shows a position of the wire assembly machine 3 in which the strand bundlers 7 have been returned to the open position. Fig. 1i shows a position of the wire assembly machine 3 in which the conductor 6 with all exposed strands 9 with the strand bundlers 7 open has been pushed further into the conductor end piece 22 for the crimping process, compared to FIG. 1h, wherein this process is not strictly necessary. FIG. 1j shows a position of the wire assembly machine 3 in which the crimping devices 21 perform a crimping stroke so that the conductor end piece 22 is crimped to the conductor 6.

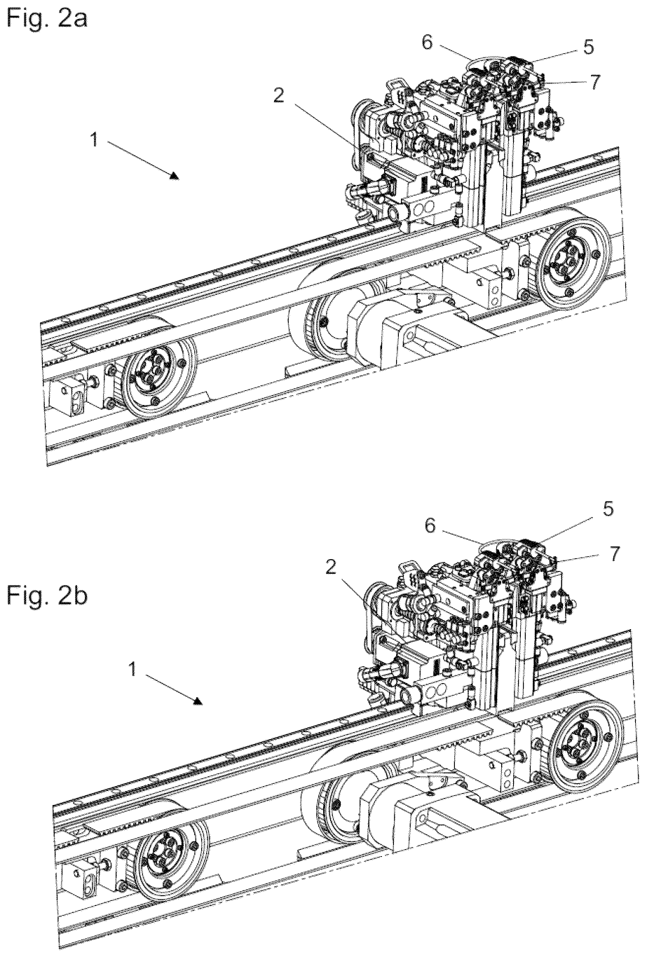

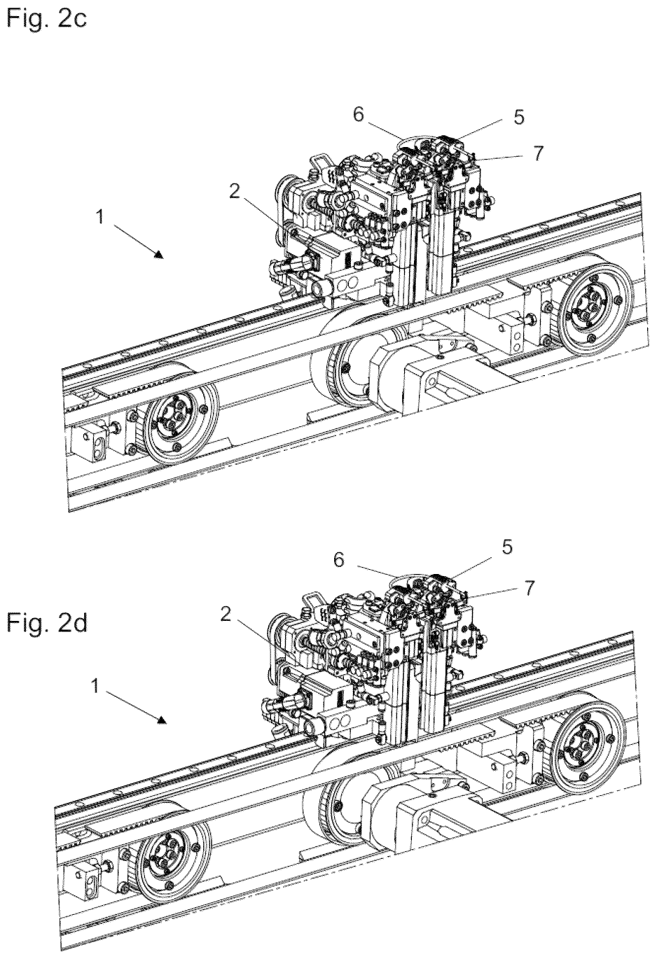

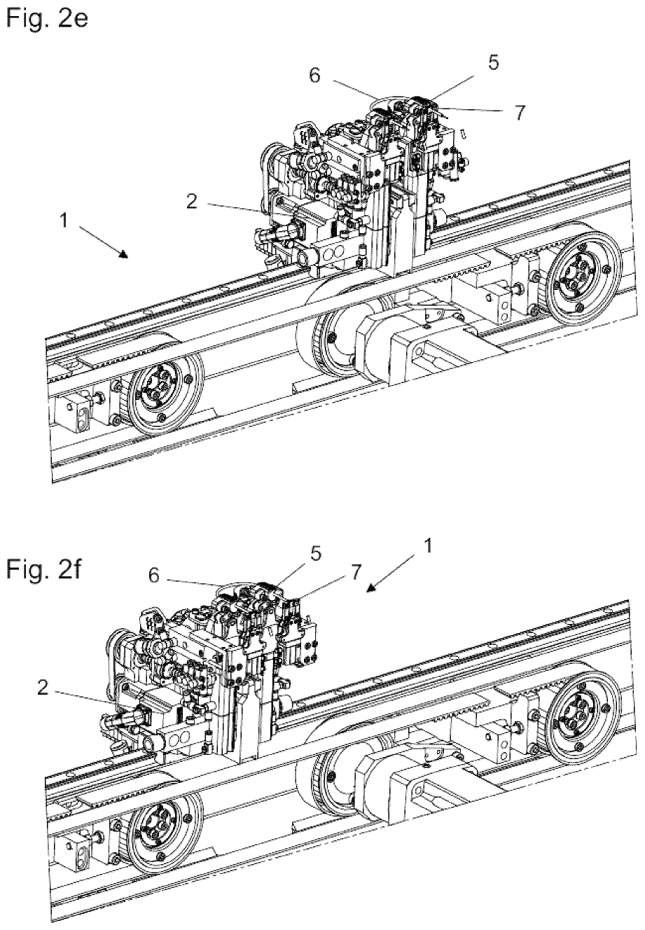

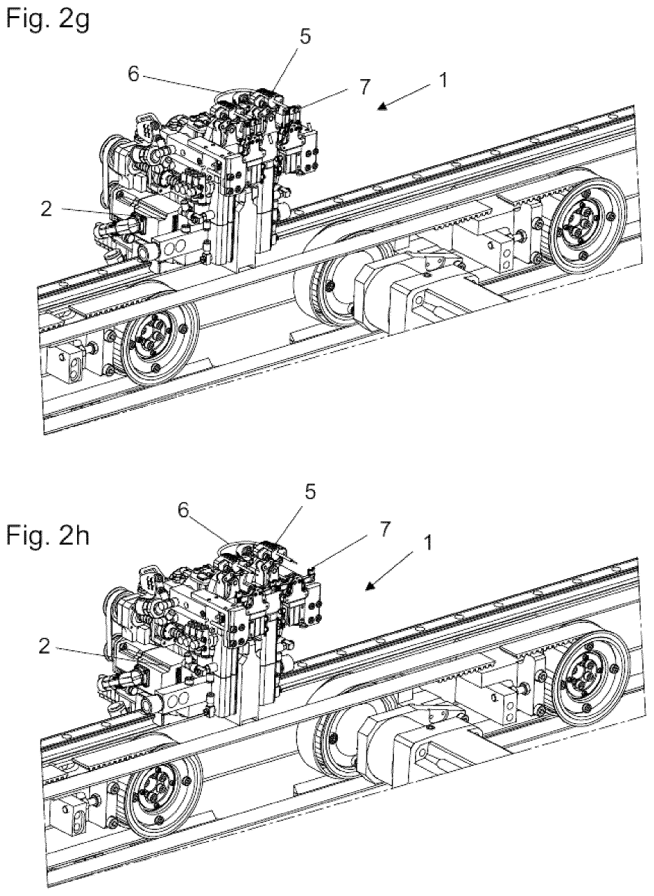

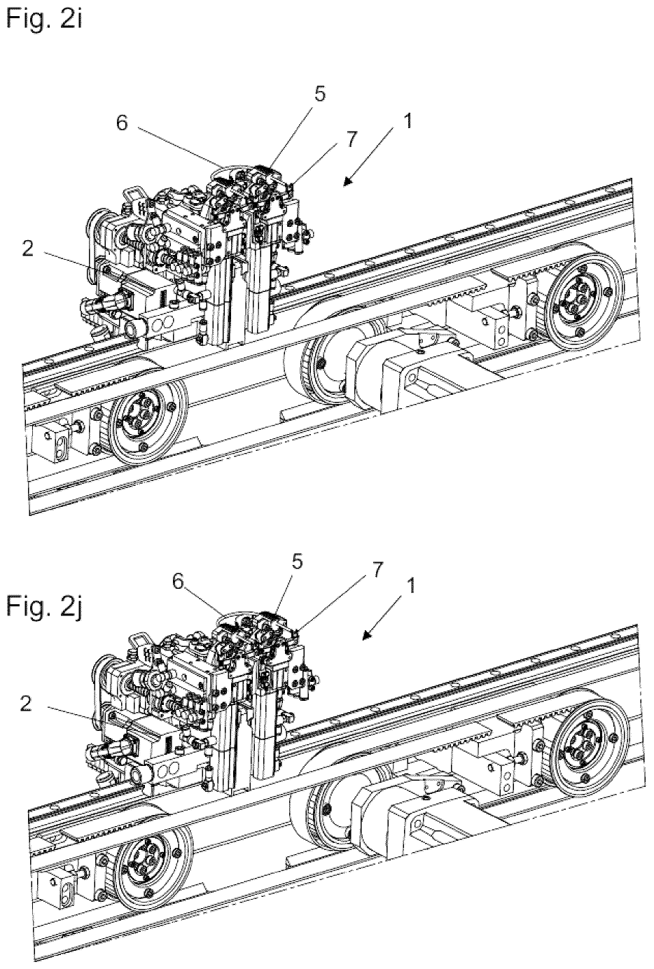

In chronological order, FIG. 2a to FIG. 2j show representations of the positions of the shuttle 2 corresponding to Fig. 1a to FIG. 1j for visualizing the arrangement of the strand bundlers 7 in the preferred illustrated sequence of transport of the shuttle 2 in coupling with the strand bundlers 7.

An exemplary method for bundling exposed strands 9 of the conductor 6 for the wire assembly machine 3 by the handling system 1 can be explained as follows: The conductor 6 is arranged on the shuttle 2 via the grippers 5 (see FIG. 2a and FIG. 2b), the conductor 6 is partially freed from the insulation 8 at the stripping units 20 to expose the strands 9 (see FIG. 2c to FIG. 2e) and the conductor 6 is transported by the shuttle 2 from the stripping units 20 to the crimping devices 21 (see FIG. 2f) in order to introduce the exposed strands 9 in bundled form into the crimping devices 21 for crimping (see FIG. 2g to FIG. 2j), wherein the strand bundlers 7 arranged between the grippers 5 and a free end 11 of the conductor 6 bundle the exposed strands 9 bundled before transport to the crimping devices 21 (see FIG. 2e). In general, the exposed strands 9 can be bundled during or after transportation to the crimping devices 21 (or the crimping device 21).

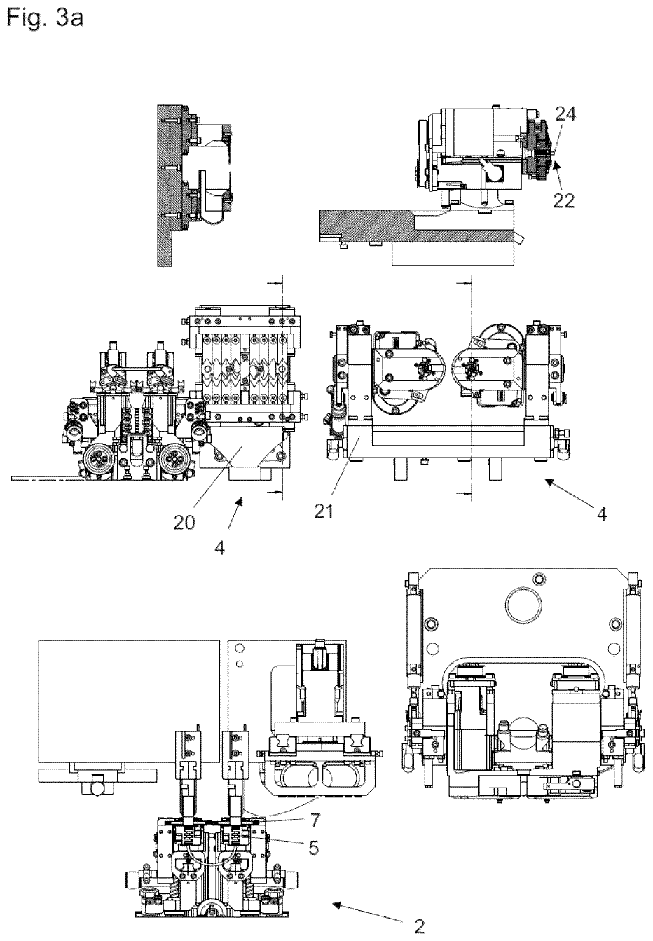

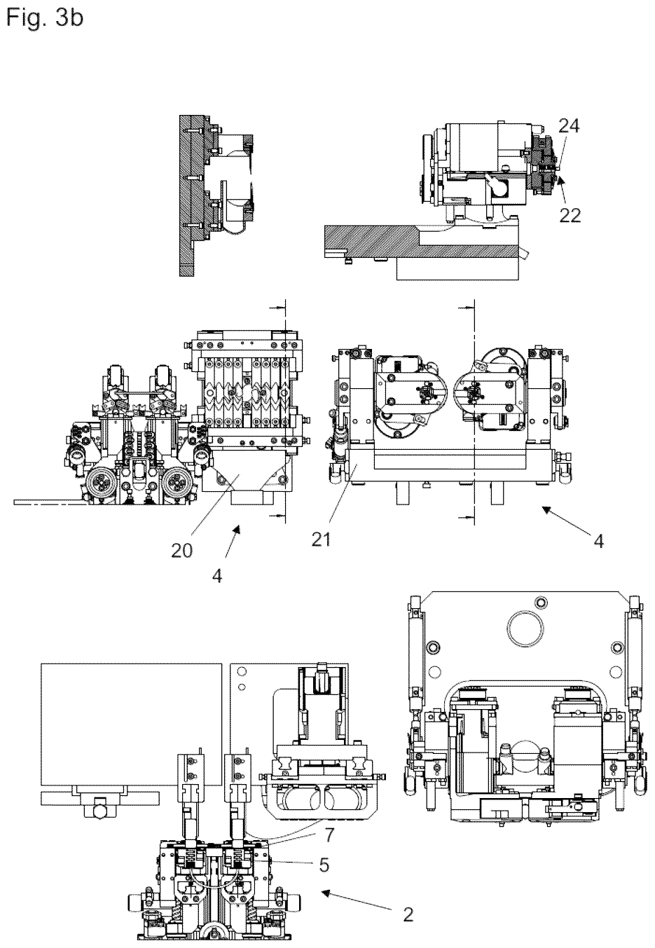

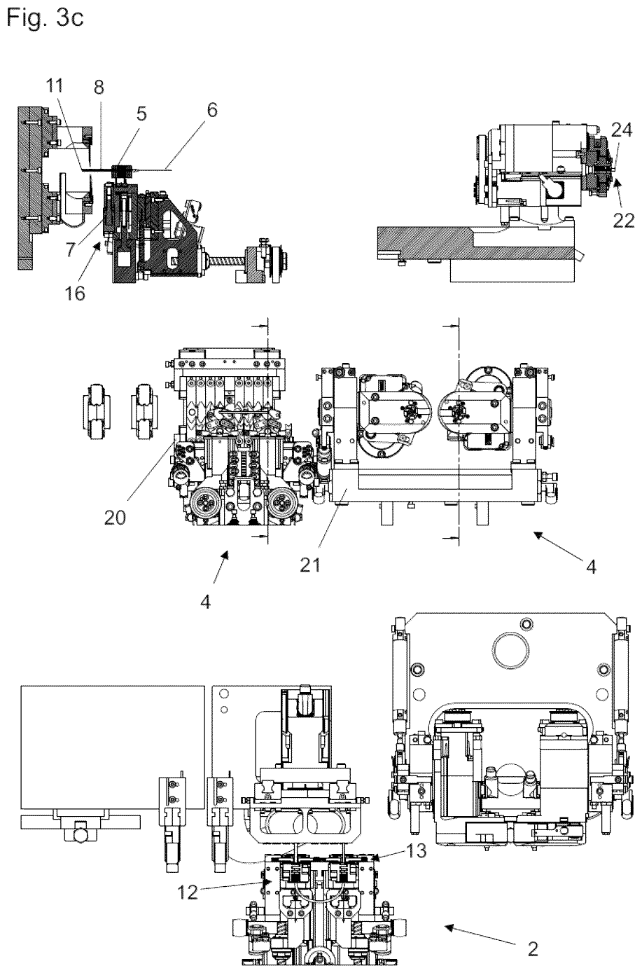

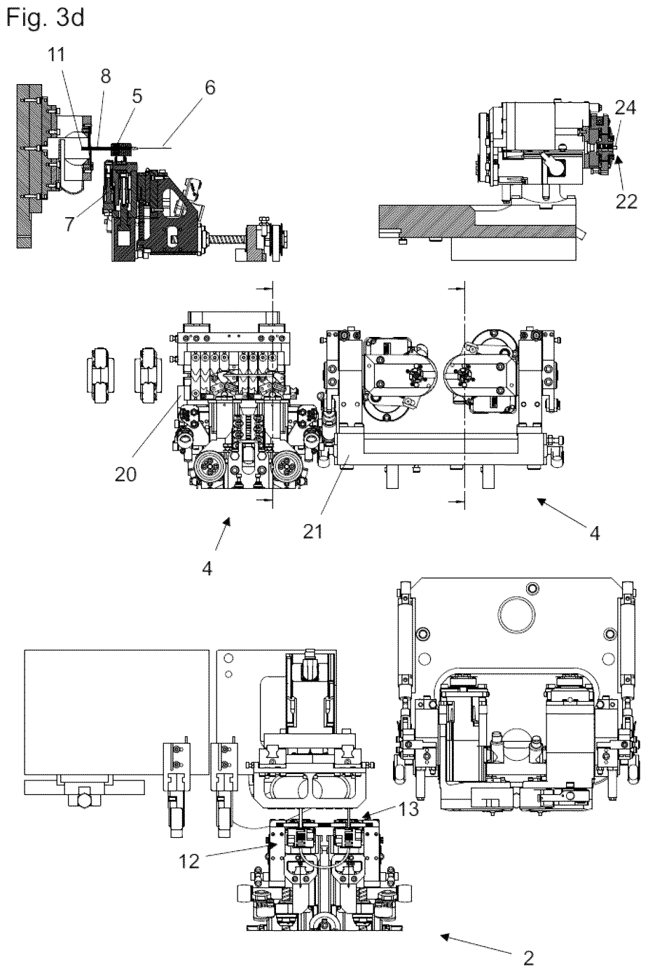

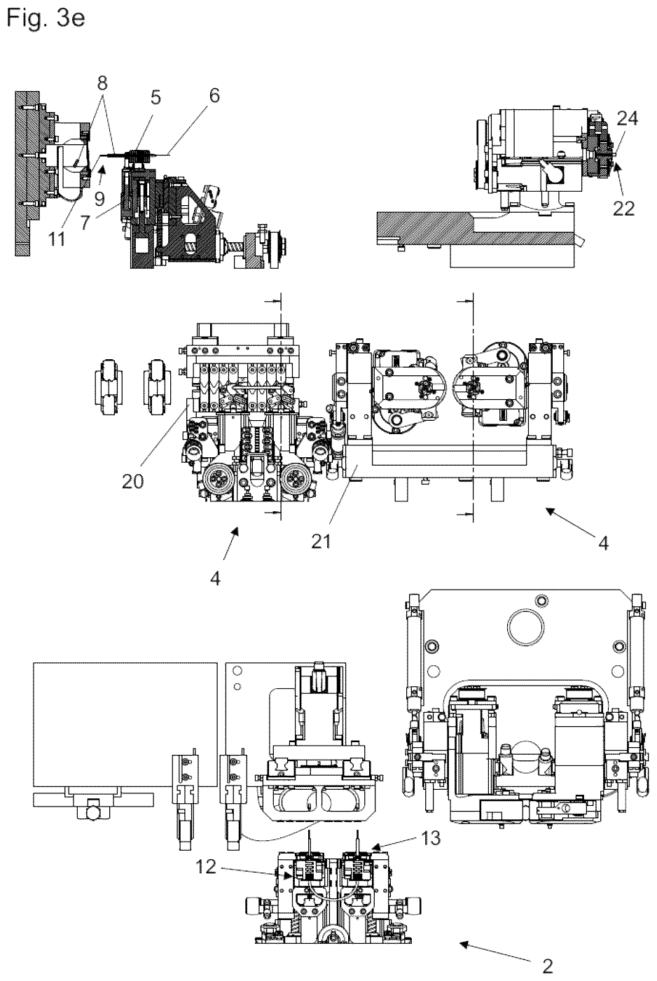

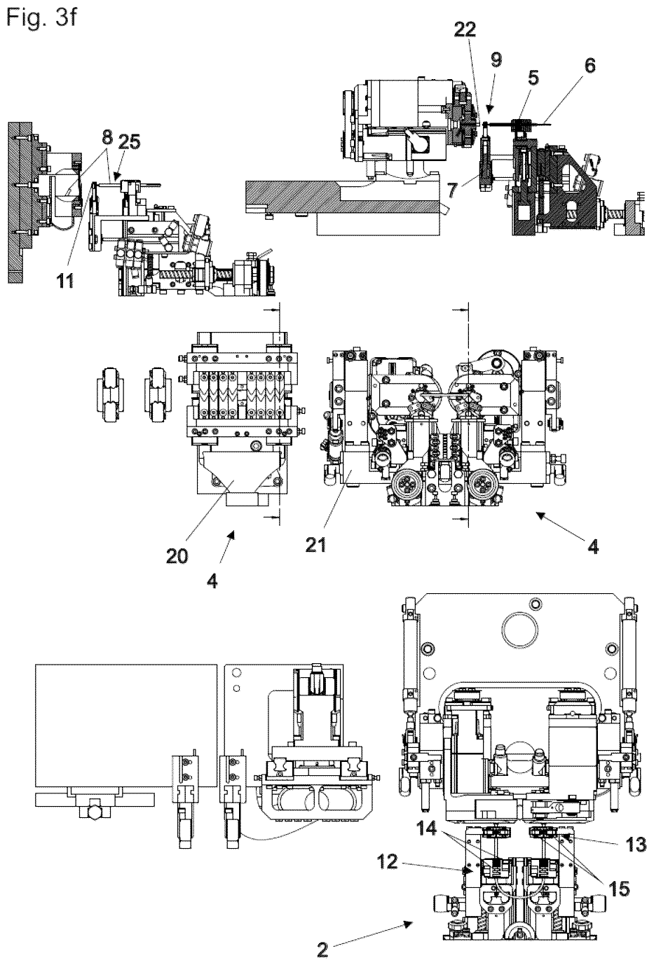

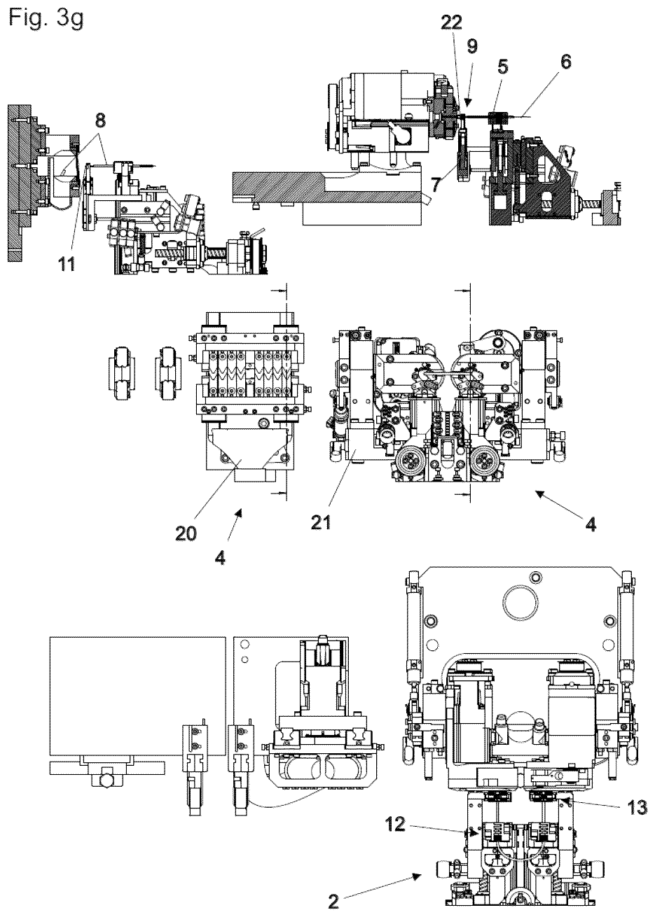

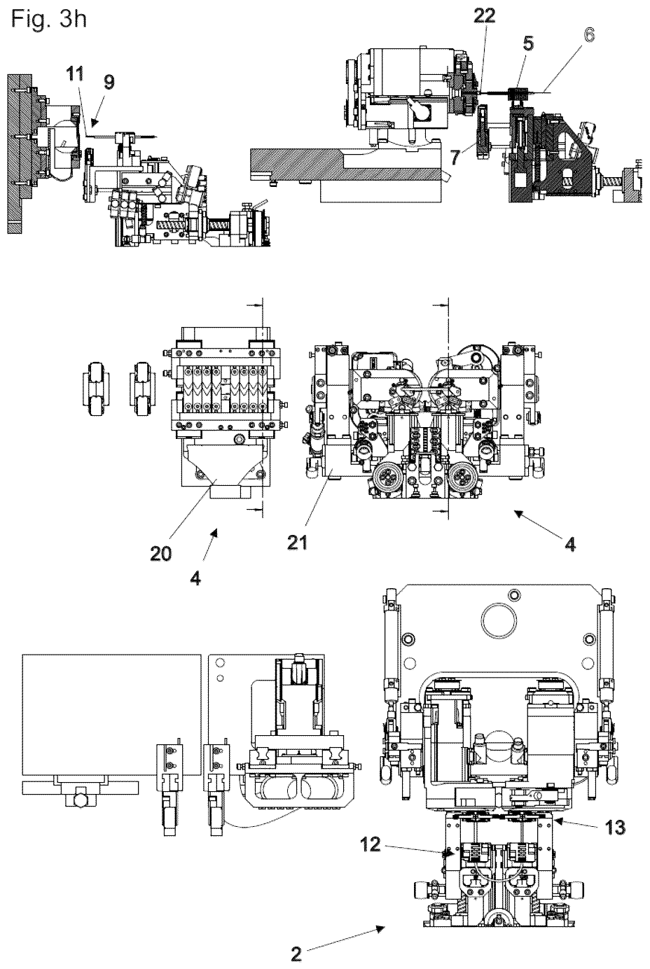

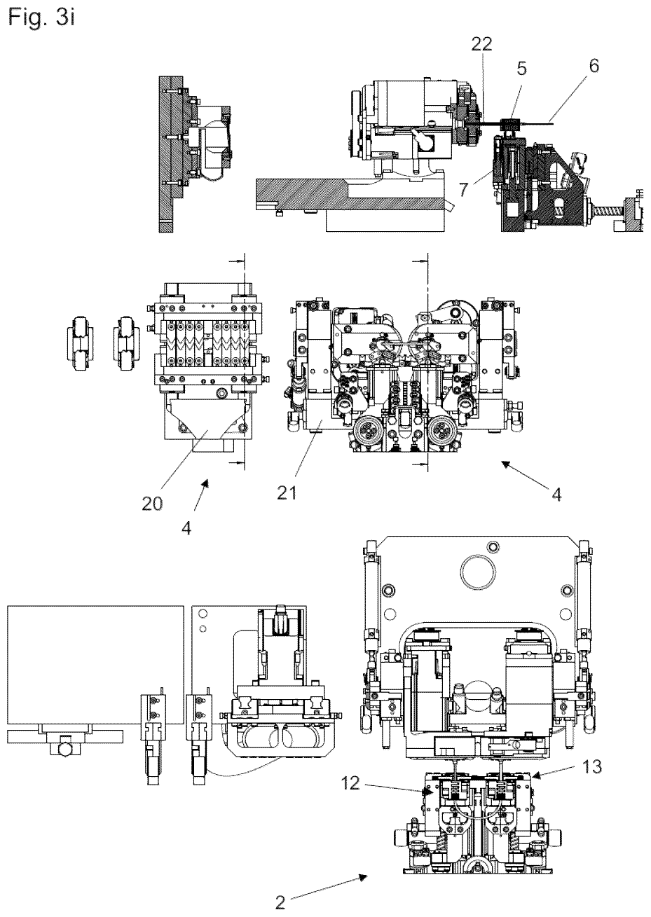

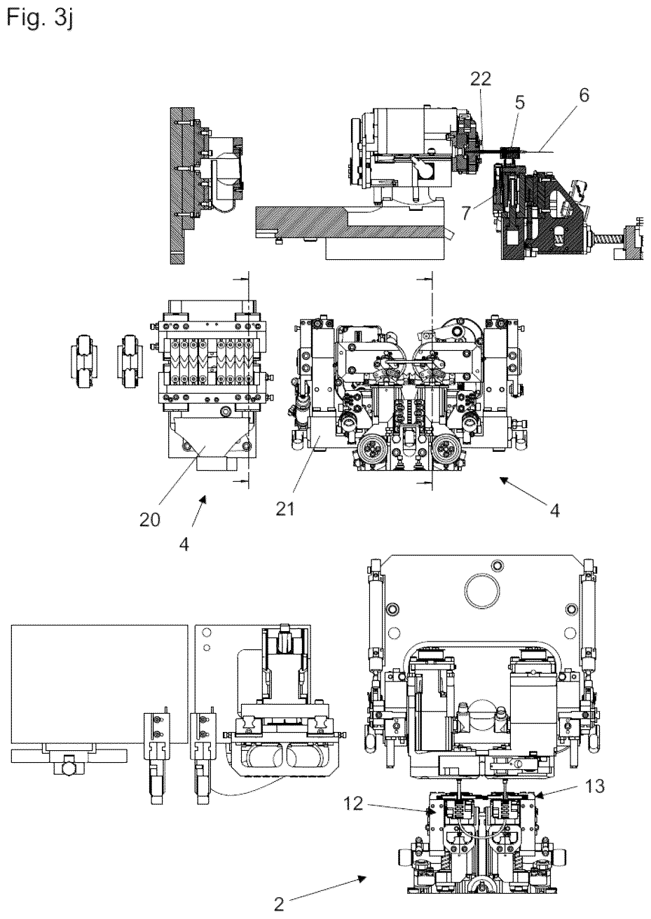

In chronological order, FIG. 3a to FIG. 3j show representations of the component parts involved in the course of transport of the shuttle 2 together with the strand bundlers 7 corresponding to FIG. 1a to FIG. 1j for visualizing the relative positioning of the strand bundlers 7 (or the strand bundler 7) in the exemplary transport sequence of the shuttle 2.

The shuttle 2 in FIG. 3a comprises a movement device (not shown in the view for reasons of clarity) with which the grippers 5 and the strand bundlers 7 can be displaced in a translational and servo-controlled manner along the wire assembly machine 3.

The strand bundlers 7 can be displaced in a direction transverse to the transport direction 10 of the shuttle 2 (along the wire assembly machine 3) in a movement-decoupled manner by the grippers 5 (orthogonal to the transport direction 10). The strands 9 exposed along the transport path of the shuttle 2 can be bundled and kept centered by the strand bundlers 7 before, during or after a transport of the strand bundlers 7.

FIG. 3b differs from FIG. 3a only in that the transfer grippers have been opened for the transfer of the conductor 6 to the shuttle 2.

FIG. 3c shows that the strand bundlers 7 are arranged on the shuttle 2 in such a way that the strand bundlers 7 are arranged between a free end 11 of the conductor 6 and the grippers 5 and oriented parallel to the grippers 5 when the conductor 6 is arranged on the shuttle 2.

The strand bundlers 7 comprise a drive device 16 for opening and closing the strand bundlers 7, wherein the drive device 16 is configured such that the drive device 16 opens or closes the strand bundlers 7 before, during or after a transport of the shuttle 2 or the strand bundlers 7 to one of the wire end processing stations 4.

The drive device 16 is pneumatic, wherein alternatively or additionally other actuators can also be provided in order to open or close the strand bundler(s) 7.

FIG. 3d differs from FIG. 3c only in that blades of the stripping units 20 were moved in the direction of the conductor 6 in order to sever or at least cut into the insulation 8.

FIG. 3e shows that the strand bundlers 7 together with the grippers 5 were moved relative to the stripping units 20 in order to partially remove the insulation 8 from the conductor 6. During this movement, the strand bundlers 7 were transferred to the closed position in the region of the remaining insulation 8, wherein in general a closed position in the region of the exposed strands 9 or a subsequent transfer of the strand bundlers 7 to the closed position is also possible.

In the transport position of the shuttle 2, the strand bundlers 7 are arranged on the stripping unit 20 (or on the crimping device 21) between the stripping unit 20 (or on the crimping device 21) and the grippers 5.

FIG. 3f shows that the strand bundlers 7 can be displaced in a motion-decoupled manner in the direction of the wire end processing stations 4 and orthogonally to the transport direction 10 of the shuttle 2 by the grippers 5 for bundling the exposed strands 9 for the centered insertion of the exposed strands 9 into a collar 24 of the conductor end piece 22 (see relative positioning of the strand bundlers 7 with respect to the grippers 5 in FIGS. 3e and 3f).

The strand bundlers 7 can carry out the bundling process immediately after the strands 9 have been exposed by the strand bundlers 7 on the stripping unit 21 or during the transport of the conductor 6 by the shuttle 2 from the stripping unit 20 to the crimping device 21 or on the crimping device 21 by closing the strand bundlers 7. Shown is that variant of the invention in which the strand bundlers 7 move into the closed position during transport along the longitudinal extension 19 of the wire assembly machine 3.

The shuttle 2 has two grippers 5 designed as a double gripper system 12 and arranged on the same shuttle 2 for holding two free ends 11 of the conductor 6. The grippers 5 have two holding jaws 14 for force-fitting holding in the region of a free end 11 of the conductor 6.

The shuttle 2 has two strand bundlers 7 designed as a further double gripper system 13 and arranged on the same shuttle 2 for centering and holding the exposed strands 9. The strand bundlers 7 have two bundler jaws 15 for the force-fitting holding of the exposed strands 9 in the region of a free end 11 of the conductor 6.

FIG. 3g to FIG. 3i show that the bundled exposed strands 9 are inserted into the conductor end piece 22 in some regions, the strand bundlers 7 are opened and the exposed strands 9 are properly located in the conductor end piece 22, so that a particularly favorable crimp connection is generated between the conductor 6 and the conductor end piece 22.

The strand bundlers 7 can be openedduring or after insertion of the exposed strands 9 into the conductor end piece 22 via the strand bundlers 7 on the crimping device 21, wherein the exposed strands 9 are optionally kept bundled in a centered manner by the strand bundlers 7 during transport of the shuttle 2 from the stripping units 20 to the crimping devices 21.

For example, the exposed strands 9 can be bundled in a centered manner on an outer diameter 25 of the insulation 8 of the conductor 6 by a relative movement of the strand bundlers 7 with respect to the grippers 5 or the wire end processing station 4 in a direction transverse to the transport direction 10 of the shuttle 2 and the longitudinal extension 19 of the wire assembly device 3.

FIG. 3i shows that the strand bundlers 7 can already be returned to the starting position—in the open position adjacent to the grippers 5 or contacting them—before the crimp connection is completed by the crimping device 21, wherein the time of opening and the relative displacement of the strand bundlers 7 can be selected as desired.

For example, the strand bundlers 7 can be transferred to the starting position on the shuttle 2 (according to FIG. 3a) by decoupling the movement from the grippers 5 in the course of a relative movement of the grippers 5 with respect to the crimping device 21 (for the bundled or centered insertion of the exposed strands 9 into the collar 24 of the conductor end piece 22).

FIG. 3j shows the conductor 6, which has been connected to the conductor end piece 22 by the crimping device 21 by means of plastic deformation to complete the crimping process as wire end processing of the conductor 6.

### LIST OF REFERENCE NUMERALS:

handling system (1)
shuttle (2)
wire assembly machine (3)
wire end processing station (4)
gripper (5)
conductor (6)
strand bundler (7)
insulation (8)
exposed strands (9)
transport direction (10)
free end (11)
double gripper system (12)
additional double gripper system (13)
holding jaw (14)
bundler jaw (15)
drive device (16)
longitudinal extension (19)
stripping unit (20)
crimping device (21)
conductor end piece (22)
collar (24)
outer diameter (25)

1. A handling system in the form of at least one shuttle for a wire assembly machine comprising a plurality of wire end processing stations, wherein the at least one shuttle comprises:
at least one gripper for holding at least one conductor; and
at least one strand bundler separate from the at least one gripper for bundling exposed strands, preferably from 3 mm to 30 mm and/or exposed from an insulation, of the at least one conductor,
wherein the at least one strand bundler is arranged on the at least one shuttle in such a way that the at least one strand bundler is movement-coupled to the at least one gripper in a transport direction of the at least one shuttle.

2. The handling system according to claim 1, wherein the at least one strand bundler is arranged on the at least one shuttle in such a way that the at least one strand bundler is arranged between a free end of the conductor and the at least one gripper and/or oriented parallel to the at least one gripper when a conductor is arranged on the at least one shuttle.

3. The handling system according to claim 1, wherein the at least one shuttle has at least two grippers, preferably designed as a double gripper system and/or arranged on the same shuttle, for holding two free ends of a conductor and/or the at least one gripper has two holding jaws for force-fitting holding in the region of a free end of a conductor.

4. The handling system according to claim 1, wherein the at least one shuttle has at least two strand bundlers, preferably designed as a further double gripper system and/or arranged on the same shuttle, for centering and holding the exposed strands and/or has two bundler jaws for force-fittingly holding the exposed strands in the region of a free end of the at least one conductor.

5. The handling system according to claim 1, wherein the at least one strand bundler comprises at least one, preferably pneumatic, drive device for opening and/or closing the at least one strand bundler, wherein it is preferably provided that the at least one drive device is configured such that the at least one drive device opens and/or closes the at least one strand bundler before or during or after a transport of the at least one strand bundler via the at least one shuttle.

6. The handling system according to claim 1, wherein the at least one shuttle comprises a movement device for the translational and/or servo-controlled transport of the at least one gripper and the at least one strand bundler, wherein he at least one strand bundler is displaceable in a direction transverse to a transport direction of the at least one shuttle in a motion-decoupled manner from the at least one gripper and/or the exposed strands can be bundled and/or held centered by the at least one strand bundler before or during or after a transport of the at least one strand bundler.

7. A wire assembly machine comprising at least two wire end processing stations and the handling system according to claim 1 for transporting at least one conductor between the at least two wire end processing stations.

8. The wire assembly machine according to claim 7, wherein the at least two wire end processing stations are arranged along a longitudinal extension, and the at least one shuttle is movable along the longitudinal extension.

9. The wire assembly machine according to claim 7, wherein one of the at least two wire end processing stations is in the form of at least one, preferably at least two, stripping units for partially removing an insulation of the at least one conductor and/or at least one, preferably at least two, crimping devices for crimping the exposed strands with a conductor end piece, preferably a wire end ferrule, twisted contact, cable lug, flat plug sleeve or crimp connection.

10. The wire assembly machine according to claim 7, wherein the at least one strand bundler is arranged in at least one transport position of the at least one shuttle, preferably in the region of one of the at least two wire end processing stations, between one of the at least two wire end processing stations and the at least one gripper, wherein it is preferably provided that the at least one strand bundler can be displaced in the direction of one of the at least two wire end processing stations and/or orthogonally to a transport direction of the at least one shuttle by the at least one gripper, preferably for inserting the exposed strands into at least one collar of at least one conductor end piece, in a motion-decoupled manner.

11. The wire assembly machine according to claim 7, wherein the at least one strand bundler comprises at least one drive device for opening and/or closing the at least one strand bundler, wherein the at least one drive device is configured such that the at least one drive device opens and/or closes the at least one strand bundler before or during or after transport of the at least one shuttle to one of the at least two wire end processing stations.

12. A method for bundling exposed strands of at least one conductor for a wire assembly machine using the handling system according to claim 1, the method comprising:
arranging the at least one conductor on the at least one shuttle via the at least one gripper;
partially stripping the at least one conductor of insulation at a stripping unit to expose the strands; and
transporting the at least one conductor by the at least one shuttle from the stripping unit to a wire end processing station, preferably a crimping device, wherein the at least one strand bundler, preferably arranged between the at least one gripper and a free end of the at least one conductor, bundles the exposed strands before or during or after transport to the wire end processing station.

13. The method according to claim 12, wherein the exposed strands are bundled substantially centered on an outer diameter of the insulation of the at least one conductor, preferably by a relative movement of the at least one strand bundler with respect to the at least one gripper and/or the stripping unit in a direction transverse to a transport direction of the at least one shuttle and/or a longitudinal extension of the wire assembly device.

14. The method according to claim 12, wherein the exposed strands of the crimping device are fed in a bundled manner by the at least one strand bundler, preferably by a relative movement of the at least one strand bundler with respect to the at least one gripper and/or the stripping unit in a direction transverse to a transport direction of the at least one shuttle and/or a longitudinal extension of the wire assembly device, wherein the exposed strands are inserted in a centered manner into a conductor end piece and crimped to the conductor end piece.

15. The method according to claim 12, wherein the at least one strand bundler is bundled during or after the exposure of the strands by the at least one strand bundler at the stripping unit and/or during a transport of the at least one conductor by the at least one shuttle from the stripping unit to the crimping device by the at least one strand bundler by closing the at least one strand bundler and/or the at least one strand bundler is opened during or after insertion of the exposed strands into a conductor end piece by the at least one strand bundler on the crimping device, wherein it is preferably provided that the exposed strands are held bundled in a centered manner by the at least one strand bundler during transport of the at least one shuttle from the stripping unit to the crimping device.
